(19) United States
(12) Patent Application Publication
(10) Pub. No.: US 2016/0125667 A1
(43) Pub. Date: May 5, 2016

(54) ANALYTIC SEQUENCING FOR RUN-TIME EXECUTION OF AIRCRAFT DATA

(71) Applicant: GE Aviation Systems LLC, Grand Rapids, MI (US)

(72) Inventor: Richard Alan Phillips, Dublin, CA (US)

(21) Appl. No.: 14/530,697

(22) Filed: Nov. 1, 2014

(51) Int. Cl. G07C 5/00; G07C 5/12; G07C 5/08

(52) U.S. Cl. CPC G07C 5/008; G07C 5/0808; G07C 5/12

(57) ABSTRACT

In one aspect, the invention relates to a fleet management system 100 for monitoring fleet data derived from aircraft 104. The fleet management system 100 comprises at least one base station 102 for receiving information from an aircraft 104 and an analytical unit 200 operably connected via a network 106 to the at least one base station 102. The analytical unit 200 is operable to analyse data derived from the aircraft 104. The analytical unit 200 also comprises a queue management module 210 for configuring analytic sequencing for run-time execution in order to analyse the fleet data derived from the aircraft 104. Data derived from the aircraft 104 can be analysed by executing a sequence of one or more analytic algorithms 304. The analytic sequencing of each respective sequence of the analytic algorithms 304 may be pre-configured by using the queue management module 210.

### FIELD

The present invention relates generally to analytic sequencing for run-time execution of aircraft data. More particularly, the present invention relates to a fleet management system for monitoring fleet data derived from aircraft, and a queue management tool for, and a method of, configuring analytic sequencing for run-time execution in order to analyse fleet data derived from aircraft.

### BACKGROUND

Over the past few decades, more and more day-to-day interactions, transactions and communications have taken place using networked systems. Many such systems are known [1, 2] but remain complex to analyse given the huge volumes and types of information flowing through them, the geographic diversity of their users, etc.

In some systems [3], analytics may be used to assess performance against various technical or business criteria targets based upon the data flowing through the systems. Such systems may even be automatically configured to improve analysis of the data that is transferred therein [4].

The recent drive towards increased data analysis has been driven, in part, by a move to businesses using the Industrial Internet (II), e.g. to monitor plant, vehicle or production performance with a view to identifying trends, predicting outage, etc. Indeed, various tools to aid such analyses are currently available, such as those that can be hosted on GE's Industrial Internet software platform Predix™ [5].

However, whilst improvements in data analytics have been made over the last few years, there remain various problems associated with the accuracy of those analytics, particularly when they are to be used in safety-critical applications such as aircraft diagnostics.

### SUMMARY

Hence, various aspects and embodiments of the present invention have been developed by the inventor.

According to a first aspect of the present invention, there is thus provided a fleet management system for monitoring fleet data derived from aircraft. The fleet management system comprises at least one base station for receiving information from an aircraft and an analytical unit operably connected via a network to the at least one base station. The analytical unit is operable to analyse data derived from the aircraft and further comprises a queue management module for configuring analytic sequencing for run-time execution in order to analyse the fleet data.

According to a second aspect of the present invention, there is also provided an analytic sequencing queue management tool for aircraft data analysis. The analytic sequencing queue management tool is operable to provide a graphical user interface (GUI) having at least one swimlane in which each analytic algorithm defining a sequence of one or more serially executable analytic algorithms is graphically represented.

According to a third aspect of the present invention, there is provided a method of configuring analytic sequencing for run-time execution in order to analyse data derived from aircraft. The method comprises providing a GUI having at least one swimlane, adding at least one analytic algorithm to a swimlane to define an executable sequence of one or more analytic algorithms therein, and storing the executable sequence of one or more analytic algorithms for subsequent use. The executable sequence of one or more analytic algorithms define the sequencing for run-time execution when analysing the data.

The various aspects of the present invention thus enable an analytical sequence to be determined and then applied to aircraft data in order to reduce the incidence of errors in the analysis. They also provide for faster development and implementation of data analysis sequences for extracting useful information from such aircraft data.

Various additional advantages will become apparent to those skilled in the art when considering the various embodiments of the present invention that are described below.

### BRIEF DESCRIPTION OF THE DRAWINGS

Various aspects and embodiments of the present invention will now be described in connection with the accompanying drawings, in which:

FIG. 1 shows a fleet management system for monitoring fleet data derived from aircraft in accordance with an embodiment of the present invention;

FIG. 2 shows an analytical unit for analysing data derived from an aircraft in accordance with an embodiment of the present invention;

FIG. 3 shows a graphical user interface (GUI) for use in an analytic sequencing queue management tool in accordance with an embodiment of the present invention;

FIG. 4 shows detail relating to an analytic algorithm that can be used in various embodiments of the present invention; and

FIG. 5 shows a method of configuring analytic sequencing for run-time execution in order to analyse fleet data derived from aircraft for use in various embodiments of the present invention.

### DETAILED DESCRIPTION

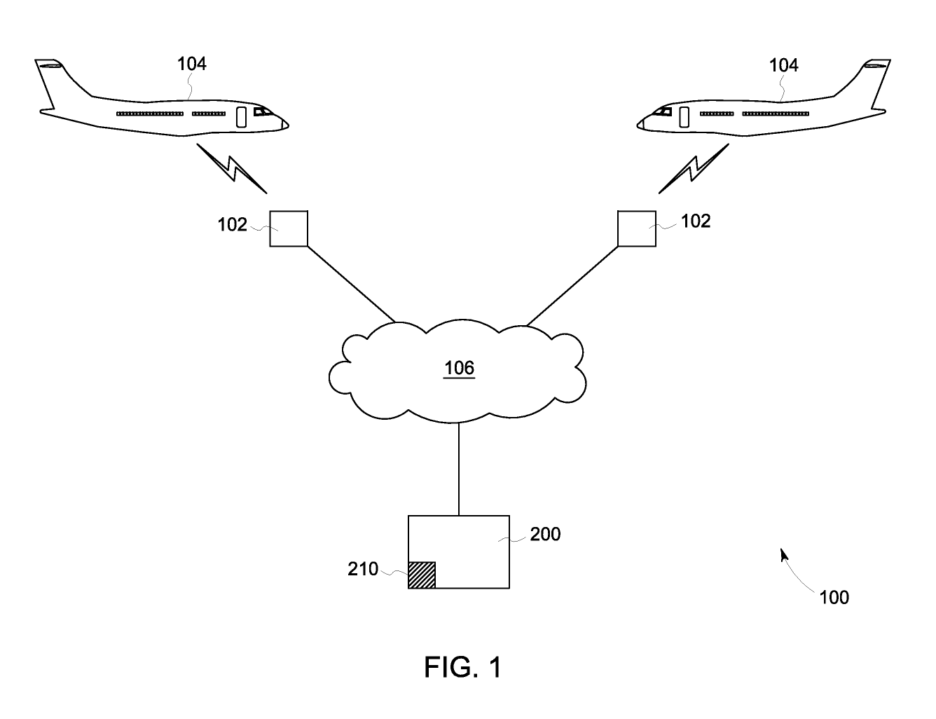

FIG. 1 shows a fleet management system 100 for monitoring fleet data derived from aircraft 104 in accordance with an embodiment of the present invention.

The fleet management system 100 comprises first and second base stations 102 for receiving information from aircraft 104. The aircraft 104 transmit data to the base stations 102 using known wireless telemetry links. The aircraft data may include, for example, aircraft position, heading, altitude, attitude, performance and speed data, as well as full flight engine data including temperature, pressure and vibration measurements, etc., plus full data bus quick access recorder (QAR) data, as determined on board the aircraft 104. Such data can be analysed to determine, for example, whether an engine needs to be overhauled or is operating sub-optimally.

The first and second base stations 102 are connected to a network 106. The network 106 may be a proprietary private network, or may correspond to the Internet being used, in this instance, as the Industrial Internet (II). Where the Internet is used for data communications, data may be transmitted using the TCP/IP protocol. Optionally, secure links may be provided using, for example, secured sockets layer (SSL) connections to prevent monitoring or tampering with the data transmissions.

An analytical unit 200 is also connected to the network 106. Data from the base stations 102 is gathered by the analytical unit 200 for analysis. Data analysis is performed by executing a sequence of one or more analytic algorithms. Such analytic algorithms may, for example, perform statistical analysis on engine performance data to determine a likely mean time before failure (MTBF) of an engine component. A subsequent analytic algorithm in the sequence may then compare the output of its predecessor to acceptable limits in order determine whether or not the engine component needs to be replaced.

The analytical unit 200 comprises a queue management module 210 for configuring analytic sequencing for run-time execution in order to analyse fleet data derived from the aircraft 104. The queue management module 210 is used to pre-configure the analytic sequencing of each respective sequence of one or more analytic algorithms 304 prior to runtime. Such pre-configured analytic sequences may be hosted by a remote source, e.g. a cloud-based server [5], a dedicated server etc., or may be created by a user modifying, for example, previously created templates of analytic sequences.

Various examples of such a queue management module 210, and techniques that can be used therewith to configure the analytic sequencing for run-time execution, are described below in relation to further embodiments of the present invention.

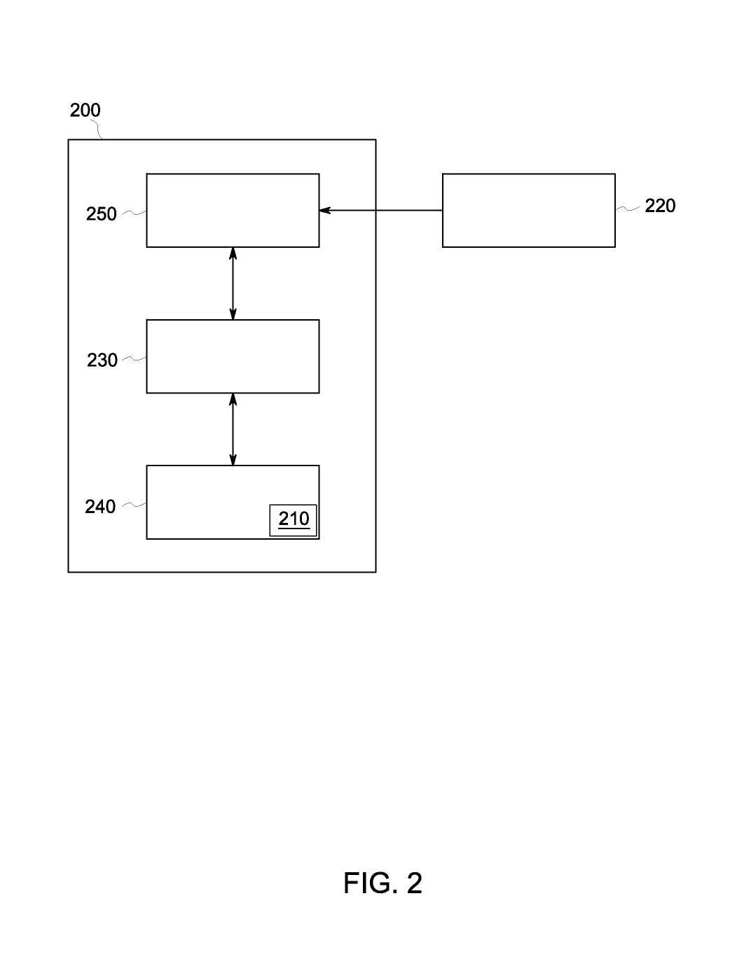

FIG. 2 shows an analytical unit 200 for analysing data derived from an aircraft 104 in accordance with an embodiment of the present invention.

The analytical unit 200 includes a processor 230 bi-directionally coupled respectively to memory 240 and a network interface 250. The analytical unit 200 also includes an analytic sequencing queue management tool 220. The analytic sequencing queue management tool 220 is used to configure queue management module 210, that in this embodiment is provided as a software service stored in the memory 240.

In various embodiments, the analytic sequencing queue management tool 220 is provided as a software tool. For example, it may be provided by using software as a service (SaaS) hosted by a cloud-based, Industrial Internet provided service [5]. It may also be provided by way of alternative delivery means.

Each sequence of one or more analytic algorithm sequences may be cloud-hosted and/or executable. In this case, the analytic unit 200 may initiate execution through the cloud, enabling the use of a thin client as the analytic unit 200 with faster execution being performed in the cloud. The analytical unit 200 may also be operable to upload modified sequences of one or more analytic algorithms as new templates, this enables efficient re-use of resources and aids in collaborative development of new analytic algorithm sequences.

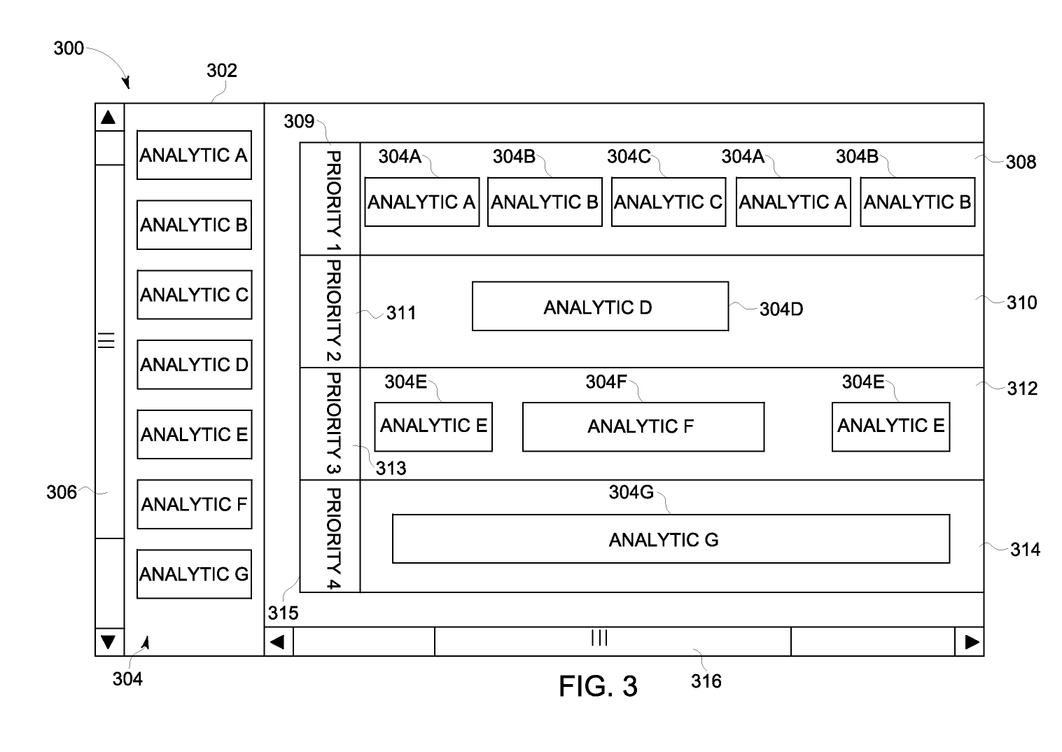

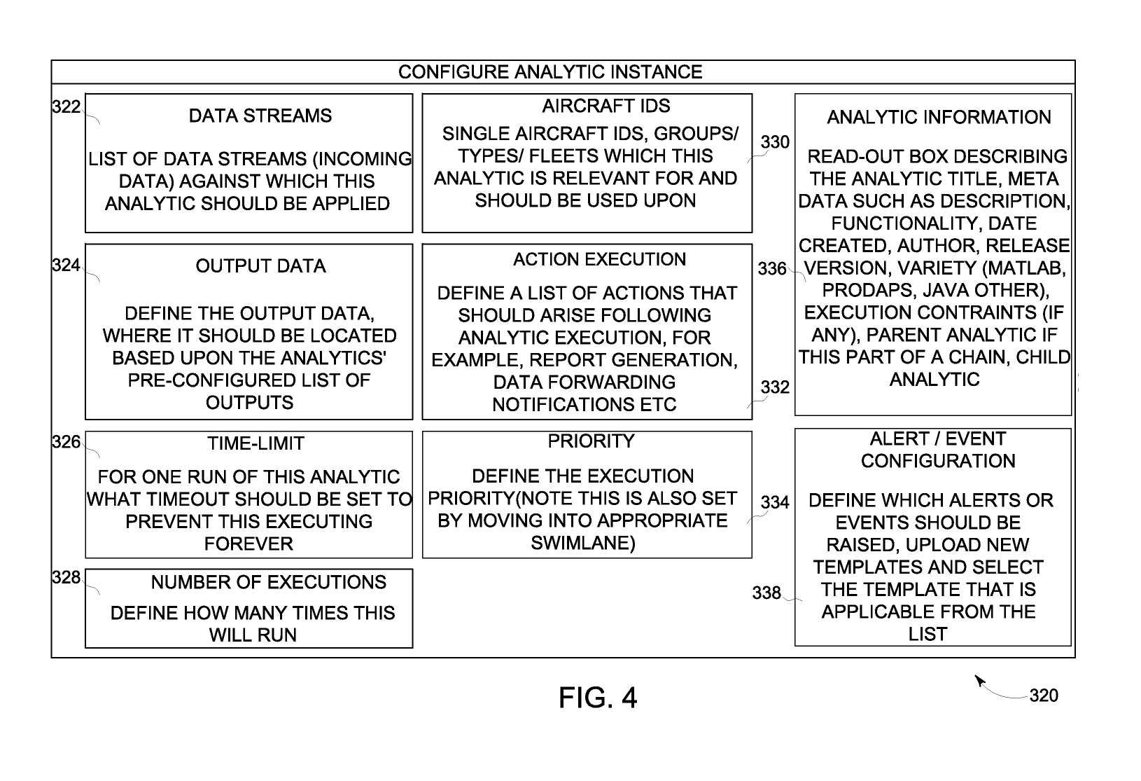

The analytic sequencing queue management tool 220 is further operable to cause the queue management module 210 to provide a graphical user interface (GUI) 300 to a user of the analytical unit 200, an example of which will be described below in connection with FIGS. 3 and 4.

FIG. 3 shows a graphical user interface (GUI) 300 for use in analytic sequencing queue management in accordance with an embodiment of the present invention. Such a GUI 300 may be used, for example, by the queue management module 210 or fleet management system 100 as described above.

The GUI 300 has a plurality of swimlanes 308, 310, 312, 314 in which analytic algorithms 304, defining a sequence of one or more analytic algorithms, are graphically represented. The graphic representations of the analytic algorithms 304 can be positioned by a user using drag and drop motion, to position them relative to one another within the swimlanes 308, 310, 312, 314 and to select which swimlane 308, 310, 312, 314 to place them into. In this embodiment, a view of the swimlanes 308, 310, 312, 314 can be scrolled from left to right and vice versa using a scroll bar 316. Each swimlane 308, 310, 312, 314 is associated with a respective lane name tab 309, 311, 313, 315. Swimlane configuration may be performed by clicking on an appropriate lane name tab 309, 311, 313, 315.

In various embodiments, a swimlane is a data area provided as part of the GUI 300 with which a user can interact. It may, for example, be a rectangular-shaped area presented on a screen to a user. Preferably, such a rectangular-shaped area has a relatively high aspect ratio such that it is generally much larger in one dimension than the other dimension. For example, the rectangular-shaped area may have a height (H) when viewed on a screen that is less than a width (W) when viewed on screen, such that H<W. In various preferred alternative embodiments, however, W=2*H, W=5*H, W=10*H, etc. to provide an aspect ratio of 2:1, 5:1, 10:1, etc. A swimlane may also be defined as a collection of analytics that may operate upon a particular type of data which is received.

First swimlane 308 includes a first analytic algorithm sequence composed of Analytic A 304A, Analytic B 304B, Analytic C 304C, Analytic A 304A, and then Analytic B 304B. The analytic algorithms 304 will execute in this serial sequence when the first analytic algorithm sequence is run using the aircraft data as the initial input, with the output of preceding analytic algorithms 304 being fed into the subsequent analytic algorithm 304 as input. A final output is obtained from the first analytic algorithm sequence when the second instance of Analytic B 304B has finished executing.

In this example, the graphical representations of the analytic algorithms 304A, 304B, and 304C in the first swimlane 308 are all the same width (i.e. W_{A}=W_{B}=W_{C}). This denotes that they all require an equal amount of time to complete their execution. However, in various embodiments, the width W of the graphical representation of an analytic algorithm 304 within the respective swimlane 308, 310, 312, 314 can be adjusted in order to change the execution time of the corresponding analytic algorithm 304. The width may be increased or decreased. Where the width is decreased a minimum limit for execution time may be reached, beyond which no further width reduction is permitted. Decreases in execution time may be affected by, for example, increasing processor thread priorities such that a processor is made aware of the need for increased processing speed of a particular analytic algorithm 304. Similarly, a decrease may be affected by reducing the processor thread priority of that analytic algorithm 304. Analytic algorithms 304 placed into a swimlane 308, 310, 312, 314 may also be roughly sized to provide their runtime, in order to limit the execution time for critical tasks.

As an example, one analytic algorithm sequence may run as follows: “Identify applicable assets”->“Collect parametric data”->“Collect environmental data”->“Collect historical data”->“Calculate time at temperature”->“calculate de-rate factors”->“apply PM10 factors”->“Alert on above threshold assets”

Second swimlane 310 includes a second analytic algorithm sequence composed of one single analytic algorithm, Analytic D 304D. The Analytic D 304D has a width in the second swimlane 310 that corresponds to about three times that of the individual analytic algorithms 304A, 304B, and 304C in the first swimlane 308 (i.e. W_{D}≈3*W_{A}). Hence, the second analytic algorithm sequence takes three times as long to execute as the respective individual analytic algorithms 304A, 304B, and 304C in the first swimlane 308.

The start of Analytic D 304D, as defined by the left hand side of the graphic that represents it, is also positioned further to the right in the swimlane 310 than that of the first instance of Analytic A 304A in swimlane 308. In various embodiments, this can be used to enable the relative start times for execution to be staggered between the analytic algorithm sequences that are defined in the swimlanes 308, 310, 312, 314. Users may therefore align the respective analytic algorithms 304 in the swimlanes 308, 310, 312, 314 in order to adjust the relative start and/or end times between the various individual analytic algorithms 304A, 304B, 304C, 304D, 304E, 304F, 304G placed therein so as to coordinate overall data analysis and the timing thereof.

Third swimlane 312 includes a third analytic algorithm sequence composed of Analytic E 304E, followed by Analytic F 304F and then Analytic E 304E again. The analytic algorithms will execute in this serial sequence when the third analytic algorithm sequence is run using the aircraft data as the initial input, with the output of preceding analytic algorithms 304 being fed into the subsequent analytic algorithm 304 as input. A final output is obtained from the first analytic algorithm sequence when the second instance of Analytic E 304E has finished executing. The Analytic E 304E has a width that corresponds to that of the analytic algorithms 304A, 304B, and 304C in the first swimlane 308 (i.e. W_{E}=W_{A}). However, Analytic F 304F has a width in the third swimlane 312 that corresponds to about 3.6 times that of the individual analytic algorithms 304A, 304B, and 304C in the first swimlane 308 (i.e. W_{F}≈3.6*W_{A}). Hence the total execution time for the third analytic algorithm sequence will be approximately 5.6 times that required to execute any one of the analytic algorithms 304A, 304B or 304C.

Fourth swimlane 314 includes a fourth analytic algorithm sequence composed of one single analytic algorithm, Analytic G 304G. The Analytic G 304G has a width in the fourth swimlane 314 that corresponds to about 6.7 times that of the individual analytic algorithms 304A, 304B, and 304C in the first swimlane 308 (i.e. W_{G}≈6.7*W_{A}). Hence, the fourth analytic algorithm sequence takes almost seven times as long to execute as the respective individual analytic algorithms 304A, 304B, and 304C in the first swimlane 308.

The analytic algorithm sequences may be executed serially in priority order, depending on particular data needs. However, they can be organised to run concurrently or on their own, depending upon the data analysis that is required.

GUI 300 also presents a user with a toolbar 302. The toolbar 302 shows graphic representations of the analytic algorithms 304 that are available for use, for example, by way of a list of icons showing all available analytics that can be applied to data received for a particular aircraft. These representations can be dragged and dropped into the swimlanes 308, 310, 312, 314 as required by the user, with those that cannot be daisy-chained to pre-selected analytic algorithms 304 already in a particular swimlane 308, 310, 312, 314 being greyed-out. This may occur, for example, where the input of one analytic algorithm 304 is incompatible with that of a previously selected analytic algorithm 304. In this embodiment, the user can also scroll through the toolbar 302 using scroll bar 306 to enable them to view all of the available analytic algorithms 304. The user may also double click the graphic representations of the analytic algorithms 304 in the toolbar 302 in order to reveal their properties.

A position of an analytic algorithm 304 within the respective swimlane 308, 310, 312, 314 defines a relative execution time with respect to any other analytic algorithms 304 depicted within the same swimlane 308, 310, 312, 314. However, if only one analytic algorithms 304 is provided in a particular swimlane 308, 310, 312, 314, then execution will begin with that analytic algorithm 304. As the user adds analytic algorithms 304 to the a swimlane 308, 310, 312, 314 the GUI 300 is configured to chain inputs and outputs between the individual analytic algorithms 304 together, with data flow therebetween being automatically configured in order to produce an analytic algorithm sequence.

The swimlanes 308, 310, 312, 314 may also be configured to display a name, author and revision. They, or the individual analytic algorithms 304, may also be associated with information relating to a certificate, e.g. for indicating that the analytics being used therein are valid, and may display such certificate information in various appropriate properties dialog boxes.

In this embodiment, the plurality of swimlanes 308, 310, 312, 314 are vertically stacked with respect to one another. The relative vertical positions of the swimlanes 308, 310, 312, 314 defines a respective execution priority of the sequence of one or more analytic algorithms 304 within that swimlane 308, 310, 312, 314 with respect to the remaining swimlanes 308, 310, 312, 314. In this case, the uppermost swimlane 308 is accorded the highest execution priority such that the first analytic algorithm sequence executes in preference to the second analytic algorithm sequence, etc. Swimlane 314 is accorded the lowest execution priority. The priority accorded may indicate a runtime priority that will dictate the amount of processor and memory resource that will be allocated at runtime. In the GUI 300 shown, the user may drag and drop entire swimlanes 308, 310, 312, 314 with respect to one another in order to change the relative priorities thereof.

FIG. 4 shows detail relating to an analytic algorithm that can be used in various embodiments of the present invention. In particular, a configuration interface 320 is shown. The configuration interface 320 may be presented to the user, for example, when operating the GUI 300 and should they click the right-hand button of a mouse when a cursor is positioned over one of the graphic depictions of an analytic algorithm 304.

The configuration interface 320 is used to configure an analytic instance (e.g. the individual analytic algorithm 304A). By clicking on data streams block 322 the user is able to enter a list of data streams (incoming data) against which the corresponding analytic algorithm 304 should be applied. Similarly, output data block 324 enables the user to enter data that defines the output data and where it should be located based upon a pre-configured list of outputs for the analytic algorithm 304.

A time-limit block 326 enables the user to add data indicating what the timeout limit should be for one execution of the analytic algorithm 304 in order to prevent it going into an infinite loop. Number of executions block 328 is user-configurable to define how many times the analytic algorithm 304 will run.

By clicking on aircraft IDs block 330 the user is able to enter data indicating single aircraft identifications, group identifications, type identifications, and/or fleet identifications for which the analytic algorithm 304 is relevant and to which the analytic algorithm 304 should be applied.

Action execution block 332 enables the user to define a list of actions that should arise following execution of the analytic algorithm 304, such as, for example, report generation, data forwarding notifications, etc.

Priority block 334 defines the execution priority of the analytic algorithm 304. The priority may be set by the user by way of this priority block 334. The data values therein may also be modified using the GUI 300 by moving the relative positions of the swimlanes 308, 310, 312, 314 with respect to one another.

Analytic information block 336 provides a configurable read-out box describing the title of the analytic algorithm 304, meta data such as a description, date created, author, release version, variety (e.g. MatLab®, proDAPs®, Java®, etc.), parent analytic (if part of a chain), child analytic, etc.

Alert/event configuration block 338 is also provided. Alert/event configuration block 338 is used to define which alerts or events should be raised, upload new templates and select a template that is applicable from a template list.

When an analytic algorithm 304 is selected and placed into a sequence, there may be further sequence specific configuration needed. For example, maximum execution time, data to be passed from one analytic algorithm 304 to the next, etc. Clicking the analytic boxes in each sequence will pop-up a dialog to enable configuration of those parameters.

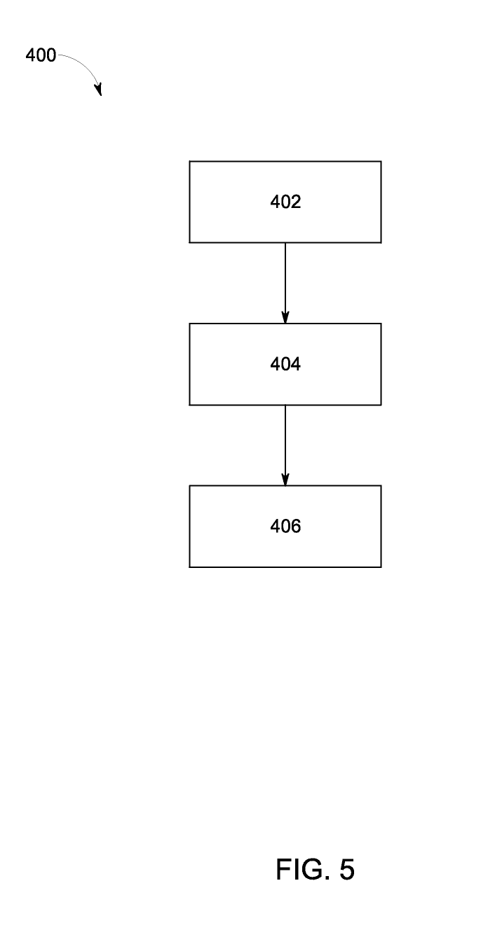

FIG. 5 shows a method 400 of configuring analytic sequencing for run-time execution in order to analyse fleet data derived from aircraft 104 for use in various embodiments of the present invention.

The method 400 comprises a first step 402 of providing a graphical user interface, such as for example GUI 300 as described above, having at least one swimlane. At step 404 at least one analytic algorithm is added to a chosen swimlane to define an executable sequence of one or more analytic algorithms therein. At step 406, the executable sequence of one or more analytic algorithms is stored for subsequent use. The executable sequence of one or more analytic algorithms defines the sequencing for run-time execution when analysing the data.

In step 406, the executable sequence of one or more analytic algorithms may be stored as a template. Such templates may, for example, be uploaded to a template server, or to the cloud, so they can be subsequently accessed and used by multiple users. Such templates thus facilitate collaboration during major development programs by allowing rapid dissemination of shared resources. Alternatively, configured sequences may be used that can be loaded into a library of sequence configurations. Such sequence configurations may be specific and static in nature. Processing of the aircraft data is itself preferably cloud-hosted.

In various embodiments, the step 404 comprises dragging and dropping a graphical representation of the at least one analytic algorithm 304 into the swimlane. This step 404 may be performed by various users, including those that are not experts in data analytics, and enables rapid and accurate production of analytic algorithm sequences for analysing aircraft data. Such analytic algorithm sequences may also be built-up automatically using the latest templates available to perform a particular analysis, thereby providing optimal version control across multi-user platforms.

Data linkage between the respective analytic algorithms 304 in the swimlane may also be automatically configured, e.g. by adding code to convert the data formats, parse data streams, etc. For example, blocks may be provided between the analytic algorithms, possibly having their own associated GUI's. Such blocks may then perform an extract, transform, and load (ETL) translation before the next analytic executes. Such blocks may thus be used to streamline the analytic algorithms, which would otherwise have to format output as well perform results calculations. The blocks could thus be used to effectively provide a “mini” enterprise service bus (ESB) between the analytic algorithms.

In various embodiments entire swimlanes can be dragged and dropped to change the relative positions thereof in order to modify respective execution priorities of the sequences of one or more analytic algorithms within the respective swimlanes. Resource allocation, e.g. processor time and/or memory allocation provided at runtime, may be set in accordance with such priorities. Graphical representations of the analytic algorithms may also be dragged and dropped with respect to one another within their respective swimlanes in order to change the relative execution times of the analytic algorithms. The size of the graphical representations of the at least one analytic algorithm within a respective swimlane may further be modified in order to change the execution duration period of a respective analytic algorithm.

Various embodiments of the present invention have thus been described herein. Those skilled in the art will be well-aware that such embodiments may be implemented as desired by using, for example, one or more software, hardware and/or firmware-based elements.

1. A fleet management system for monitoring fleet data derived from aircraft, the fleet management system comprising:
at least one base station for receiving information from an aircraft; and
an analytical unit operably connected via a network to said at least one base station, the analytical unit being operable to analyse data derived from the aircraft, wherein the analytical unit further comprises a queue management module for configuring analytic sequencing for run-time execution in order to analyse fleet data derived from aircraft.

2. The fleet management system of claim 1, wherein the data derived from the aircraft is analysed by executing a sequence of one or more analytic algorithms, the analytic sequencing of each respective sequence of one or more analytic algorithms being pre-configured by said queue management module.

3. The fleet management system of claim 2, wherein each sequence of one or more analytic algorithms is associated with a respective execution priority.

4. The fleet management system of claim 1, wherein the network operates in accordance with the TCP/IP protocol.

5. The fleet management system of claim 4, wherein each sequence of one or more analytic algorithms are cloud-hosted and/or executable.

6. The fleet management system of claim 1, wherein the queue management module is operable to provide a graphical user interface GUI having at least one swimlane in which each analytic algorithm, defining a sequence of one or more analytic algorithms, is graphically represented.

7. The fleet management system of claim 6, wherein a position of an analytic algorithm within the respective swimlane defines a relative execution time with respect to any other analytic algorithms depicted within the same swimlane.

8. The fleet management system of claim 6, wherein a width (W) of the graphical representation of an analytic algorithm within the respective swimlane denotes an execution time for said analytic algorithm.

9. The fleet management system of claim 6, said GUI further providing a plurality of swimlanes, and wherein a respective vertical position of a swimlane defines a respective execution priority of the sequence of one or more analytic algorithms within that swimlane with respect to the remaining swimlanes.

10. An analytic sequencing queue management tool for aircraft data analysis operable to provide:
a graphical user interface GUI having at least one swimlane in which each analytic algorithm defining a sequence of one or more serially executable analytic algorithms is graphically represented.

11. The analytic sequencing queue management tool of claim 10, wherein a position of an analytic algorithm within a respective swimlane defines a relative execution time with respect to any other analytic algorithms depicted within the same swimlane.

12. The analytic sequencing queue management tool of claim 10, wherein a width (W) of the graphical representation of an analytic algorithm within the respective swimlane denotes an execution time for said analytic algorithm.

13. The analytic sequencing queue management tool of claim 10, said GUI further providing a plurality of swimlanes, and wherein a respective vertical position of a swimlane defines a respective execution priority of the sequence of one or more analytic algorithms within that swimlane with respect to the remaining swimlanes.

14. The analytic sequencing queue management tool of claim 10, said GUI further providing a toolbar depicting available analytic algorithms that can be added into the swimlanes.

15. A method of configuring analytic sequencing for run-time execution in order to analyse data derived from aircraft, the method comprising:
providing a graphical user interface GUI having at least one swimlane;
adding at least one analytic algorithm to a swimlane to define an executable sequence of one or more analytic algorithms therein; and
storing said executable sequence of one or more analytic algorithms for subsequent use, said executable sequence of one or more analytic algorithms defining the sequencing for run-time execution when analysing the data.

16. The method of claim 15, wherein the step of adding at least one analytic algorithm to a swimlane comprises dragging and dropping a graphical representation of the at least one analytic algorithm into the swimlane.

17. The method of claim 15, further comprising dragging and dropping entire swimlanes to change the relative positions thereof in order to modify respective execution priorities of the sequences of one or more analytic algorithms within the respective swimlanes.

18. The method of claim 15, further comprising dragging and dropping graphical representations of analytic algorithms with respect to one another within their respective swimlanes in order to change the relative execution times of the analytic algorithms.

19. The method of any of claim 15, further comprising modifying the size of the graphical representations of the at least one analytic algorithm within a respective swimlane in order to change the execution duration period of a respective analytic algorithm.

20. The method of claim 15, wherein the step of storing said executable sequence of one or more analytic algorithms for subsequent use comprises storing the executable sequence of one or more analytic algorithms as a template.
